(19) United States
(12) Patent Application Publication
(10) Pub. No.: US 2024/0328810 A1
(43) Pub. Date: Oct. 3, 2024

(54) METHOD FOR OPERATING A HEAD-MOUNTED DISPLAY IN A MOTOR VEHICLE DURING A JOURNEY, CORRESPONDINGLY OPERABLE HEAD-MOUNTED DISPLAY AND MOTOR VEHICLE

(71) Applicant: HOLORIDE GMBH, München (DE)

(72) Inventor: Gerrit LOCHMANN, Koblenz (DE)

(21) Appl. No.: 18/576,637

(22) PCT Filed: Jul. 6, 2022
(86) PCT No.: PCT/EP2022/068741

§ 371 Date: Jan. 4, 2024

(30) Foreign Application Priority Data
Jul. 6, 2021 (DE) 10 2021 117 453.8

(51) Int. Cl. G01C 21/36; G06T 19/00

(52) U.S. Cl. CPC G01C 21/365; G06T 19/003; G06T 19/006

(57) ABSTRACT

The invention relates to a method for operating a head-mounted display (17) in a motor vehicle (10) during a journey through a real external environment (11). In this method individual images or frames of a view (21) of a virtual environment (20) are successively newly rendered, so that the virtual environment (20) can be kept congruent with the real external environment (11), and by shifting and/or rotating the view (21) of the virtual environment (20) it is possible to compensate for a change in a position (19) of the head-mounted display caused by a head movement and/or a travelling movement. According to the invention pixels of the relevant frame (40) are rendered in at least two different contextual levels and thereafter the relevant frame is composed of the pixels of the contextual levels, the pixels of different virtual objects (22) being displayed in each of the contextual levels, and when the frames (40) are newly rendered (38) for the shifting and/or rotation of the view (21) in at least two of the contextual levels, different position signals (36, 37) are used as the basis.

### FIELD

The invention relates to a method for operating a head-mounted display (HMD) in a motor vehicle while the motor vehicle performs a journey through a real external environment. By means of the head-mounted display, a view of a virtual environment is overlaid on the field of view for a user. It can be effected as virtual reality (VR) or as augmented reality (AR). Therein, the virtual environment is kept contact analogue to the real external environment, i.e. a coordinate system of the virtual environment is kept congruent with and/or tracked to a coordinate system of the real external environment in that a movement of the head-mounted display with respect to the real external environment is compensated for in the frames of the view successively newly calculated with a preset frame rate.

### BACKGROUND

Virtual-reality headsets represent virtual scenes of an environment in that individual images or frames of a virtual 3D scene are rendered for both eyes in real time on two screens integrated in the head-mounted display, while the view or perspective is determined by the sensor technology (e.g. an IMU—inertial measurement unit) integrated in the head-mounted display and the resulting display pose (display position and/or display orientation) is transferred to the virtual rendering camera. This keeps the coordinate systems of the virtual environment and of the real external environment congruent and/or it at least tracks the coordinate system of the virtual world to the coordinate system of the real external environment.

If the temporal resolution (frame rate) of the rendered images or frames therein falls below the physical temporal resolution (display refresh rate) or the latency between pose measurement and rendering result increases—for instance by a too high complexity of the graphic calculations—the disparity between the current display pose and the display pose at the point of time of the rendering start of the respective frame, which served as a basis of the lately displayed image, increases upon a head movement. This effect is disadvantageous in that individual virtual objects of the virtual environment jumpily move (which is an example for rendering artifacts), and therefore in particular granular structures, such as text, can be tracked in the virtual environment by the user with the view only with great viewing effort.

In order to correct the disparity and to ensure a response time as fast as possible, a so-called asynchronous reprojection of intermediate images or intermediate frames can be generated based on the most current measured head pose in known manner e.g. in a parallel rendering thread, which is referred to as asynchronous time warp (ATW) or asynchronous space warp (ASW) or positional space warp (PSW) according to configuration. This correction in intermediate frames increases the quality of a VR experience, but in particular makes itself noticeable in particular in case of fast head movements by undefined (e.g. black represented) edge areas in the periphery of the view to the virtual environment. Moreover, the pixel shift in the warp (e.g. by means of homographic reprojection) is applied to the entire image/the entire frame (i.e. in the global space of the background panorama or the global layer) without consideration of the context of the represented virtual objects. In certain situations, this assumption provides false results. Instead of reducing rendering artifacts, inverse rendering artifacts are induced as a result. In particular virtual objects, which are to be fixed in the field of view of the user (e.g. in a HUD—head-up display), or overlaid text begin to flicker back and forth although they only would have to be rendered at the same location and moved together with the head. This is a further example for rendering artifacts.

In state of the art applications, the VR programmer recently obtains the possibility of determining a separate contextual layer as a fixed space in the 3D scene, to which the homographic reprojection is not applied and which is unchanged superimposed after the correction of the remaining scene contents in a final compositing step.

However, more complex correlations arise in rendering and in the homographic reprojection if the head-mounted display is used in a travelling motor vehicle. Here, e.g. a head rotation of the user has to be differentiated from cornering of the motor vehicle to render or to calculate a correct view of the virtual environment although both movements represent a rotation of the head-mounted display with respect to an external environment of the motor vehicle, different rendering artifacts can arise from the perspective of the user (i.e. in the rendered view of the virtual environment). They can e.g. cause the motion sickness (kinetosis) at the user, in particular if the user views information, e.g. numbers or text, in the virtual environment, i.e. if the user generally views granular structures or textures.

In U.S. Pat. No. 10,223,835 B2, a warping is described using the example of a HUD.

In US 2017/0251176 A1, a variant of the generation of intermediate frames is described for the case that a frame rate is too low due to a great transmission latency.

### SUMMARY

The invention is based on the object to keep a viewing effort of a user of a head-mounted display and rendering artifacts in particular in visually tracking a granular structure or texture such as text during a journey in a motor vehicle low.

An aspect of the invention includes a method for operating a head-mounted display in a motor vehicle while the motor vehicle performs a journey through a real external environment. A processor circuit overlays a view of a virtual environment with virtual objects contained therein on a field of view of a user via the head-mounted display, who wears the head-mounted display for this purpose. Therein, a coordinate system of the virtual environment is kept congruent with and/or tracked to a coordinate system of the real external environment in successively newly calculated or rendered individual images or frames of the view. The new calculation/the new rendering is effected with a preset frame rate, which can result from the available computing power and the complexity of the view (number and richness of detail of the objects) among other things. In the view of the virtual environment as it is shown to the user in the head-mounted display, thus, static virtual objects do not rotate with the head of the user, but they maintain their position in the space, in particular with respect to the real external environment. This is also referred to as contact analogous display. Another description is that the north of the virtual environment remains oriented to the north of the real external environment. If the user rotates the head very fast, thus, at least this orientation is tracked in multiple successive frames until the coordinate systems are again congruent. By this orientation, the user moves in the virtual environment as the head-mounted display moves in the real environment. This can be effected for six dimensions (three translational movement directions x, y, z and three rotational movements by rotation around the spatial axes x, z, z) or only in three dimensions (the three said rotational directions around the three spatial axes). From the view of the user, thus, the camera pose of the rendering camera is oriented in the virtual environment in the same manner as it is measured for the display pose of the head-mounted display in the real external environment. A movement of the head-mounted display then corresponds to a movement of the rendering camera, which then sets the rendered view to the virtual environment.

This is effected in that by shifting and/or rotating the view of the virtual environment, a change of a display pose of the head-mounted display with respect to the real external environment caused by a head movement of the user and/or a travelling movement of the motor vehicle in the real external environment is simulated in the opposite direction. If the user for example rotates to the right with the head and thus pivots the head-mounted display to the right, thus, the at least one virtual object of the virtual environment is correspondingly moved or rotated to the left by the corresponding solid angle in the view, whereby it seems to poise in the space independently of the movement of the head-mounted display or of the change of the display pose of the head-mounted display from the view of the user. The change of the display pose can be measured in that the current spatial orientation (orientation vector or viewing direction vector) is cyclically measured and/or translational and/or rotational movement dynamics (speed and/or acceleration) are measured. The measurement can each be effected at least by means of a sensor for position markers and/or a movement sensor and/or acceleration sensor (IMU).

By at least one pose signal resulting from it, a target pose for the view in the virtual environment results, i.e. that target pose, which the rendering camera is to take in the virtual environment. In contrast, if the vehicle pose is signaled by a pose signal, thus, a target pose of a virtual representation of the motor vehicle results from it in the virtual environment. Thus, it is described by the at least one pose signal, which current display pose the head-mounted display has with respect to an interior of the motor vehicle and/or with respect to the external environment and/or which vehicle pose the motor vehicle has with respect to the external environment and/or with respect to the head-mounted display. The respective pose signal can e.g. indicate an angle indication (e.g. an angle pose around at least one spatial axis) and/or a direction vector and/or a cardinal direction and/or an angular speed and/or an angular acceleration and/or a position coordinate with respect to the respective coordinate system, to name just examples. The shift and/or rotation of the view is effected as a function of this at least one pose signal, which describes the new display pose and/or vehicle pose resulting from the head movement and/or the travelling movement.

In order to reduce rendering artifacts, it has proven to be advantageous when pixels of the respective frames are rendered or calculated in at least two different contextual layers (contextual levels) and the respective frame is thereafter composed from the pixels of the contextual layers, wherein in each of the contextual layers the pixels of different ones of the virtual objects are represented, and for newly calculating or newly rendering the frames for shifting and/or rotating the view in at least two of the contextual layers, different pose signals are taken as a basis. It is to be noted that the described “pixel shift” can represent a linear shift of pixels or a non-rectilinear shift, i.e. a distortion and/or an expansion/compression. This is generally known as pixel warping. The pixels can each be kept stored as pixel data or image data, i.e. as color values and/or brightness values, in a respective data storage or graphic buffer of the respective contextual layer. The pixels of two contextual layers can for example be composed by so-called alpha blending, which is also referred to as compositing. The pixel information or image information of individual or separated virtual objects is thus provided in different contextual layers and for each contextual layer and thereby for each virtual object represented therein, thus, the adaptation of the view of this virtual object can be separately effected depending on a change of the display pose and/or the vehicle pose. Those areas of a contextual layer, in which the virtual object is not visible, can be marked as “transparent”, as it is known from alpha blending, such that a virtual object from another contextual layer becomes visible in composing or compositing the frame in such an area. The contextual layers can also be characterized to the effect which contextual layer is above which other contextual layer from the view of the user, thus is closer to the user in the view than another contextual layer, whereby a superposition of virtual objects can be correctly represented corresponding to the perspective of the user.

By the invention, the advantage arises that an individual or adapted pose signal can be taken as a basis for individual virtual objects. Hereby, a virtual object, the object pose (position and/or spatial orientation) of which in the virtual environment is to be kept congruent or corresponding to a pose of a real object, can be controlled by a pose signal of this real object. If a virtual object for example represents the motor vehicle, thus, the virtual object pose thereof in the virtual environment can be oriented by the pose signal for the vehicle pose. It has turned out that this advantageously reduces the rendering artifacts in rendering frames during a change of the display pose.

The invention also includes developments with features, by which additional advantages arise.

Heretofore, the rendering of the frames was described, thus, the actual new calculation of the view of the virtual world, i.e. the new calculation of the individual views of the virtual objects depending on the current display pose. As already initially described, however, with a too low frame rate, the homographic reprojection can be additionally applied. Here too, it has proven to be advantageous to separately apply the homographic reprojection to the different virtual objects in singly individually separated manner in the respective contextual layers. Therefore, a development includes that after displaying the respectively currently calculated or rendered frames and before the next frame is readily calculated or rendered, at least an intermediate frame of the view is generated by means of a homographic reprojection and displayed, which is generated by a pixel shift of pixels representing the virtual objects of the current frame in the respective contextual layer. Herein, a shift extent of the pixel shift is separately performed individually for the respective contextual layer depending on the at least one pose signal used or considered or associated therein. Thereby, the pixel shift each has a different shift extent. The respective intermediate frame is then composed of the shifted pixels of the contextual layers. Thus, an individual pose signal is also taken as a basis for each contextual layer for the homographic reprojection. It is to be noted that two or more contextual layers can additionally also use a common pose signal. However, it is assumed that at least one pose signal differs in the different contextual layers, in that this pose signal is used in a contextual layer, but is ignored in another contextual layer. By the application of the homographic reprojection separately to the individual contextual layers, the advantage arises that an update of the view of the virtual world can be effected with a higher rate than the frame rate as it is available by the rendered frames. Nevertheless, the described rendering artifacts can be avoided or at least reduced by the use of the contextual layers.

The respective pose signal can be ascertained by means of a position sensor or motion sensor or acceleration sensor, for example a sensor for a geo position (for example a receiver for a position signal of a GNSS—Global Navigation Satellite System, such as for example the GPS—Global Positioning System) and/or a speed sensor and/or an acceleration sensor (for example the said IMU). Further examples are the compass and the magnetometer, by means of which the absolute rotation in the space can be measured, and a camera-based optical tracking system, which can be installed in an HMD. The respective pose signal can also be generated from multiple position sensors by means of a sensor fusion (e.g. by averaging of sensor signals). The change of the respective pose for example of the head-mounted display and/or of the motor vehicle signaled by the pose signal can be a translational and/or rotational change, i.e. a movement in a spatial direction and/or a rotation.

A development includes that an absolute pose signal, which describes the display pose with respect to the external environment, is applied in one of the contextual layers and thereby a global layer (global level) coupled to environment is provided, and a pose signal, which describes a vehicle pose of the motor vehicle with respect to the external environment, is applied in another one of the contextual layers and a cockpit layer (cockpit level) is thereby provided, in which a cockpit (e.g. seats, instruments, control elements) and/or a body (e.g. A-pillar, hood, side mirrors) of a virtual representation of an interior of the motor vehicle and/or an avatar of the user is provided as a virtual object. Thus, the global layer represents the initially described global space, thus a background panorama or that part of the virtual environment, which is static or is rigidly arranged with respect to the real external environment (north of the global space corresponds to north in the real external environment). In addition, the cockpit layer can be displayed, i.e. the user sees an interior view of a cockpit of the virtual representation of the motor vehicle. It is to be noted that this virtual representation can simulate the appearance of the interior of the motor vehicle or can have another, separate appearance, for example an appearance of a bridge of a ship or a cockpit of an airplane or a spacecraft. The object pose of this virtual object in the cockpit layer can thus be kept congruent with the vehicle pose, while a virtual object in the global layer can be kept unmoved with respect to the external environment. This differentiation between global layer and cockpit layer has proven to be particularly advantageous for reducing rendering artifacts in case that a virtual cockpit is also represented in the view of the virtual environment, which is to correspond to the interior of the motor vehicle. Both contextual layers are shifted with respect to the user, but based on different pose signals.

A development includes that a restricted pose signal, which indicates a dynamic-limited change of the display pose with respect to the change of the display pose of the head-mounted display, is applied in one of the contextual layers and thereby a dynamic-limited contextual layer (dynamic-limited contextual level) is provided. The dynamic-limited contextual layer is coupled to the cockpit layer. A restricted pose signal, which indicates a dynamic-limited change of the display pose with respect to the actual change of the display pose, is applied in the dynamic-limited contextual layer. Thus, a virtual object in the dynamic-limited contextual layer is slower moved or pivoted than it would be correct according to the change of the display pose. Thus, a virtual object in the dynamic-limited contextual layer is trailed or an inertia is associated with the virtual object, by which a limitation of a maximum speed of change of a position change of the virtual object in the dynamic-limited contextual layer occurs. The coupling to the cockpit layer results in that it is an object, which should be represented in the cockpit layer, and is transferred into the dynamic-limited contextual layer only for limiting the dynamics. For example, it can be a writing, which is displayed on a display in the virtual interior of the motor vehicle. In order to achieve the dynamic limitation in the dynamic-limited contextual layer, a restricted pose signal is artificially generated or faked for the dynamic-limited contextual layer, in which a speed of change and/or rotational speed or angular speed is limited to a maximum speed and/or maximum rotational rate. This can be achieved by applying a low-pass filter to the pose signal of the cockpit layer itself. A virtual object represented in the dynamic-limited contextual layer seems to move through a viscous liquid or a viscous fluid from the view of the user or it seems to pivot after the head movement. As a consequence from it, a virtual object in the dynamic-limited contextual layer temporarily or transiently slips with respect to other, surrounding virtual objects from the cockpit layer. For example, if a text is rendered on a display of a virtual cockpit (e.g. a virtual instrument cluster) in the dynamic-limited contextual layer (only the text, while the surrounding display frames of the cockpit are represented in a cockpit layer itself), thus, the text can temporarily be moved or slipped out of the frame of the display, because the frame for example moves according to the speed of change of the virtual cockpit in the cockpit layer, while the text moves slowed down or restricted, i.e. dynamic-limited, in the dynamic-limited contextual layer and reaches its final target pose within the frame of the display with a time offset. This has proven to be particularly advantageous to prevent motion sickness or viewing effort in viewing virtual objects. Therefore, it is deliberately a matter of a novel movement pivoting after the cockpit space in the global space or in the dynamic-limited contextual layer, independently of the display pose, because this pivoting movement can also be performed by cornering or generally a movement of the motor vehicle with respect to its environment, even if the user therein keeps the head still (with respect to the motor vehicle).

However, in order to finally arrange a virtual object in the dynamic-limited contextual layer again in its intended or correct position with respect to the cockpit layer (e.g. in the described frame of a display) after a change of the display pose by a head movement of the user, the target pose of the virtual object to be finally taken with respect to the virtual environment has to be kept available until this final target position is taken or reached by the virtual object in the dynamic-limited contextual layer. Hereto, a development includes that a current target pose of the virtual object, towards which the virtual object is to move, in the dynamic-limited contextual layer is each read out from the current signal value of the pose signal of the cockpit layer or corresponds to it. The shift and/or rotation in the dynamic-limited contextual layer is thus performed until the actual pose of the virtual object in the dynamic-limited layer reaches the target pose, wherein the restricted pose signal hereto presets a speed of change of the object pose of the virtual object limited according to amount in the dynamic-limited contextual layer to a predetermined maximum value, which is greater than zero, in particular by a limitation according to amount to a maximum rotational rate. The restricted pose signal presets a speed of change of the object pose of the virtual object limited according to amount in the dynamic-limited contextual layer to a predetermined maximum value, which is greater than zero, in particular by a limitation according to amount to a maximum rotational rate. Here, the speed of change relates to a translational and/or rotational speed, with which the virtual object changes its object pose in the representation in the dynamic-limited contextual layer in the virtual environment or with respect to the head of the user. This speed is respectively limited to a maximum value, but which is greater than zero, i.e. it is not a virtual object fixedly adhering to the perspective of the user. By application of a limitation or a limiter, thus, the speed of change of the object pose with a slow change of the display pose (e.g. slow rotation of the head of the user) can change its object pose without delay or corresponding to this speed of the head, and only upon exceeding the maximum value, the virtual object with its actual pose temporarily or transiently remains behind the target pose to be taken. This is also referred to as rubber band effect. However, the shift and/or rotation of the object pose in the dynamic-limited contextual layer is continued until the virtual object has reached its correct target pose in the dynamic-limited contextual layer even if the head-mounted display is again static after a movement of the user.

The described rubber band effect, thus the dynamic limitation, is preferably used exclusively in rendering the frames and not for the homographic reprojection. Thus, it is in particular inactive for the homographic reprojection.

A development includes that the maximum value is adjusted as a function of a current value of the frame rate. Thus, depending on the currently available frame rate, thus the current value of the frame rate, the rubber band effect can be switched. Additionally or alternatively thereto, the maximum value can also be adjusted between different values in continuous or stepwise manner in at least two or three or four different steps. Hereto, experiments with test persons can be performed to adapt an adaptation to the current value of the frame rate to the effect that the viewing effort and/or the reduction of motion sickness in persons is achieved.

A development includes that the virtual object is a granular structure or texture in the dynamic-limited contextual layer, which represents a text and/or a value display and/or an operating menu. Generally, it can be understood as a granular structure or texture that it is image parts, which are to convey information to the user, thus for example words and/or numbers and/or values. Hereto, a value display can for example include a pointer and/or a digital display, as it can for example be provided as a tachometer in a virtual cockpit.

In order to control the newly rendering of the frames and/or the homographic reprojection in the different contextual layers, pose signals or at least one pose signal per contextual layer are used in the described manner.

A development includes that at least one of the pose signals is generated as a function of a respective sensor signal of at least one motion sensor of the head-mounted display and/or one of the pose signals as a function of a respective sensor signal of at least one motion sensor of the motor vehicle. In a head-mounted display, the described IMU and/or a camera-based observation of orientation points (position markers) in the interior of the motor vehicle can for example be used as the motion sensor (so-called inside-out tracking). The pose signal can signal the current display pose, while the underlying sensor signal can for example signal a geo position and/or relative position to the interior of the motor vehicle and/or a movement speed and/or an acceleration, wherein the speed and the acceleration can be translational and/or a translational speed and/or a rotational speed. Thus, a 6D DOF or a 3D DOF tracking (DOF—Degrees of Freedom) can be provided. The sensor signal of a motion sensor of the motor vehicle can for example be a CAN bus signal (CAN—controller area network).

A pose signal can be a composite signal, which is calculated as a function of more than one sensor signal, thus as a combination of at least two sensor signals, for example as a difference of a sensor signal of a motion sensor of the head-mounted display and a sensor signal of a motion sensor of the motor vehicle, whereby this pose signal can then signal the relative pose (relative position and/or relative orientation with respect to for example vehicle longitudinal axis) with respect to the motor vehicle. Correspondingly, a development correspondingly includes that the shift extent of the pixel shift is calculated or rendered as a function of a difference from a sensor signal of a motion sensor of the motor vehicle and a sensor signal of a motion sensor of the head-mounted display in at least one contextual layer.

A development includes that the shift extent of the pixel shift is calculated in a contextual layer as a function of a tracking signal of a head tracker of the head-mounted display operated in the motor vehicle. Hereby, the so-called outside-in tracking can be applied, that is the relative pose of the head-mounted display with respect to the motor vehicle can be ascertained from outside of the head-mounted display by the head tracker operated in the motor vehicle and observing the relative pose of the head-mounted display. Hereby, the 6D tracking (thus also relative position of the head-mounted display with respect to the motor vehicle) is in particular advantageously possible, which can in particular be effected without interfering influence of the moved external environment as it is visible through the window panes of the motor vehicle.

A development includes that the shift extent of the pixel shift is generated as a function of a sensor signal of a yaw rate sensor of the motor vehicle in at least one contextual layer, which signals a yaw rate of the motor vehicle with respect to the external environment. Hereby, the described cockpit layer can in particular be realized such that transmitting artifacts for virtual objects of a virtual cockpit can be reduced.

A further aspect of the invention includes a processor circuit for operating a head-mounted display, wherein the processor circuit comprises a data interface for receiving a respective sensor signal of at least one motion sensor and wherein the processor circuit is configured to calculate at least one pose signal, which describes a new display pose and/or vehicle pose resulting from a head movement of a user wearing the head-mounted display and/or from a travelling movement of a vehicle, from the at least one received sensor signal and to perform an embodiment of the method according to the invention.

The processor circuit represents a data processing device or a processor device. It can be configured to perform an embodiment of the method according to the invention. Hereto, the processor device can comprise at least one microprocessor and/or at least one microcontroller and/or at least one FPGA (Field Programmable Gate Array) and/or at least one DSP (Digital Signal Processor) and/or at least one ASIC (Application Specific Integrated Circuit). Furthermore, the processor circuit can comprise a program code, which is configured, upon execution by the processor circuit, to perform the embodiment of the method according to the invention. The program code can be stored in a data memory of the processor circuit.

For example, the processor circuit can be at least partially or completely fixedly installed in the motor vehicle. Additionally or alternatively thereto, the processor circuit can be completely or partially provided in a portable user appliance, mounting place, a smartphone or a tablet PC and/or a smartwatch. In case of partial provision, it is then correspondingly a distributed processor circuit, which can be arranged in more than one appliance, for example partially in the motor vehicle and partially in the user appliance and/or partially in the head-mounted display. The respective motion sensor, from which the processor circuit receives the respective sensor signal, can be integrated in the processor circuit or be connected to the processor circuit and/or at least one motion sensor can be arranged in a separate portable measurement unit, which can for example be arranged or placed in the interior of the motor vehicle. At least one motion sensor can be installed in the motor vehicle. The data interface can then be correspondingly adapted or designed by the expert to receive the respective sensor signal. The transmission of the sensor signal from a portable measurement unit and/or from the motor vehicle to the processor circuit can in particular be radio-based or wirelessly effected. However, a transmission cable can also be provided. The processor circuit, in case that it is provided outside of the head-mounted display, or those parts of the processor circuit, which are provided outside of the head-mounted display, can communicate with the head-mounted display via a wireless radio link (for example WiFi and/or Bluetooth). The data interface can also be realized based on WiFi and/or Bluetooth or USB.

A further aspect of the invention includes a head-mounted display with an embodiment of the processor circuit. In this configuration, thus, the processor circuit is integrated in the head-mounted display. This results in a particularly compact and thereby comfortable configuration, since the user can wear the processor circuit together with the head-mounted display on the head.

A further aspect of the invention relates to a motor vehicle with a sensor circuit comprising at least one motion sensor for generating at least one sensor signal, which signals a temporal course of a vehicle position and/or a speed and/or an acceleration of the motor vehicle with respect to an external environment of the motor vehicle, wherein the motor vehicle comprises a transmission circuit, which is configured to transmit the at least one sensor signal to an embodiment of the processor circuit. Thus, at least one motion sensor is integrated in the motor vehicle, the at least one sensor signal of which can be used to provide a pose signal for a vehicle pose of the motor vehicle for the virtual environment.

Preferably, the motor vehicle according to the invention is configured as a car, in particular as a passenger car or truck, or as a passenger bus or motorcycle.

The invention also includes the combinations of the features of the described embodiments. Thus, the invention also includes realizations, which each comprise a combination of the features of multiple of the described embodiments if the embodiments have not been described as mutually exclusive.

### BRIEF DESCRIPTION OF THE DRAWINGS

In the following, embodiments of the invention are described. Hereto, there shows:

FIG. 1 depicts a schematic representation of an embodiment of the motor vehicle according to the invention with an embodiment of the processor circuit according to the invention.

FIG. 2 depicts an outline for illustrating an embodiment of the method according to the invention.

FIG. 3 depicts an outline for illustrating an embodiment of the method according to the invention in generating the rubber band effect upon a head movement.

FIG. 4 depicts an outline for illustrating an embodiment of the method according to the invention in generating the rubber band effect upon cornering without head movement.

### DETAILED DESCRIPTION

The execution examples explained in the following are preferred embodiments of the invention. In the execution examples, the described components of the embodiments each represent individual features of the invention to be considered independently of each other, which also each develop the invention independently of each other. Therefore, the disclosure also is to include combinations of the features of the embodiments different from the illustrated ones. Furthermore, the described embodiments can also be supplemented by further ones of the already described features of the invention.

In the figures, identical reference characters each denote functionally identical elements.

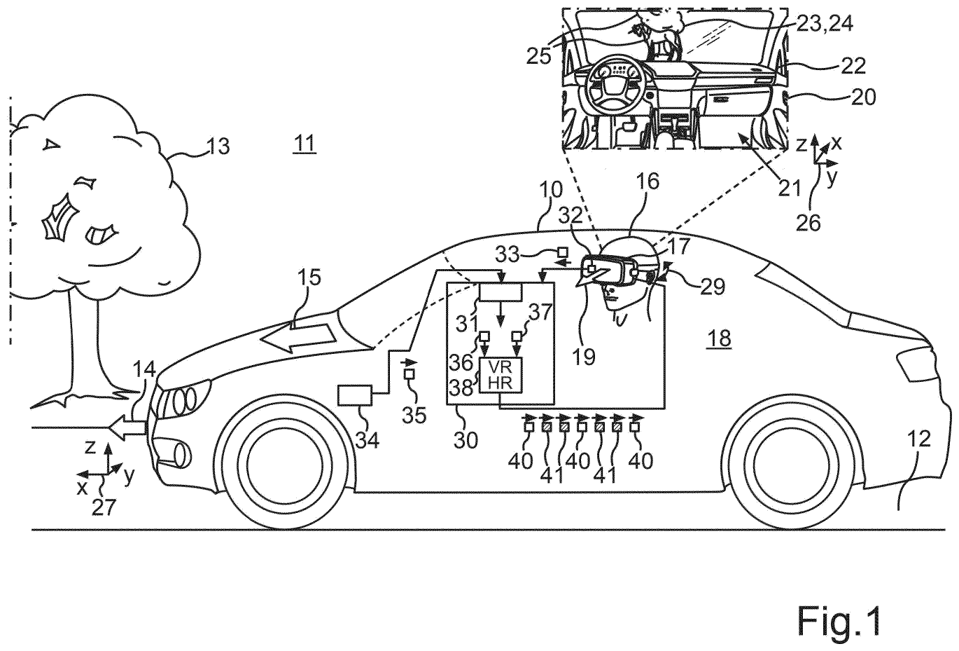

FIG. 1 shows a motor vehicle 10, which can be a car, in particular a passenger car or truck. The motor vehicle 10 can travel in an external environment 11, for example on a road 12. The external environment 11 is exemplarily represented by an environmental element 13, which is here represented as a tree. During the journey, the motor vehicle 10 changes its vehicle pose 15 by a travelling movement or vehicle movement 14, thus its position in the external environment 11 and/or its spatial orientation or alignment in the external environment 11.

During the journey, a user 16 can stay in the motor vehicle 10 and wear a head-mounted display 17 on the head and use it to view a virtual environment. By a body posture of the user 16 in an interior 18 of the motor vehicle 10, a display pose 19, thus a position of the head-mounted display 17 in the interior 18 and thereby also absolutely with respect to the external environment 11 and/or a spatial orientation or alignment of the head-mounted display 17 arises for the head-mounted display 17.

In the virtual environment 20, a view 21 can for example show a cockpit of a virtual representation of the interior 18 of the motor vehicle 10 as a possible virtual object 22. As a further virtual object 23, a background panorama 24 can for example be represented, which can for example comprise a tree and a unicorn as virtual background elements 25. The unicorn is to represent the virtual character of the representation. The tree as the virtual background element 25 can represent the real tree, thus a real environmental element 13, and can thus be represented and kept in the virtual environment in the same position, which corresponds to the position of the real environmental element 13 in the real external environment 11.

In a manner known per se, for the view 21 of the virtual environment 20, a coordinate system 26 of the virtual environment 20 can be aligned with a coordinate system 27 of the real external environment 11 or be kept congruent with it or be approximated or tracked to it. Hereto, a respective pose change 29 of the display pose 19 of the head-mounted display 17 has to be tracked in the view 21 in the opposite direction in order that the virtual object 23 for example appears rigid or static with respect to the external environment 11 in the background panorama 24 from the view of the user 16.

For this purpose, a processor circuit 30 can receive a sensor signal 33 from a motion sensor 32 of the head-mounted display 17 via a data interface 31 and a sensor signal 35 from a motion sensor 34 of the motor vehicle 10 or a portable measurement unit arranged in the motor vehicle. It can respectively be a sensor signal 33, 35 of a position and/or speed and/or rotational rate or rotational speed of the respective motion sensor 32, 34. From the sensor signals 33, 35, a pose signal 36 of the display pose 19 and a pose signal 37 of the vehicle pose 15 can be calculated by the processor circuit 30 in a manner known per se. Since the display pose 19 and the vehicle pose 15 change over time, a time signal results as the respective pose signal 36, 37. In the processor circuit 30, the view 21 to the virtual environment 20 can be updated by newly rendered frame individual images or frames 40 by rendering 38 depending on the pose signals 36, 37. Therein, the frames 40 are newly rendered or calculated in time intervals, which results in a frame rate in updating the frames 40 in the head-mounted display 17. In order to avoid rendering artifacts, it can additionally be provided to calculate intermediate frames 41 in the described manner by a homographic reprojection HR.

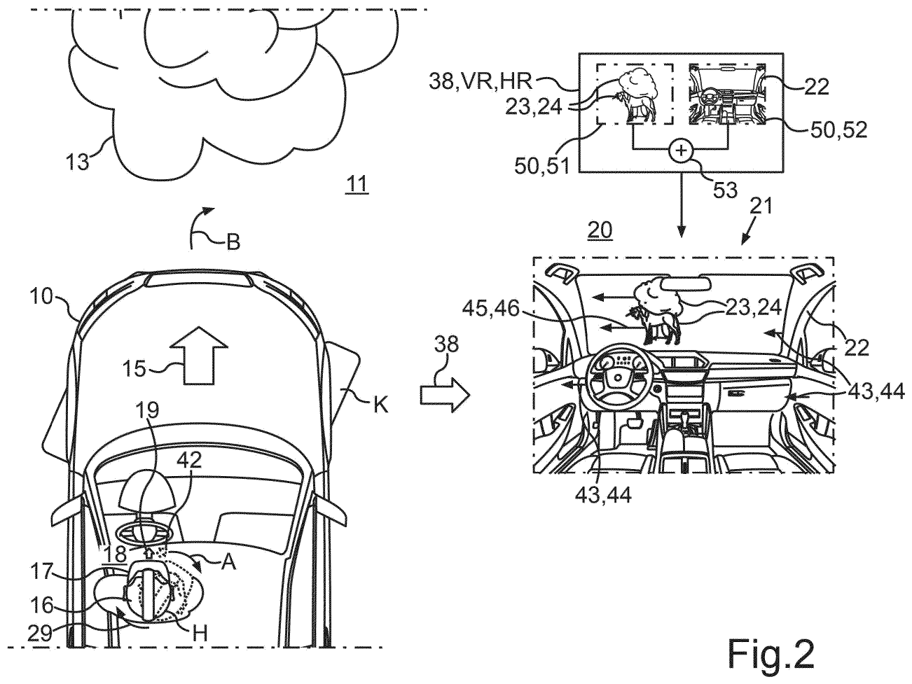

FIG. 2 illustrates, how the view 21 can be adapted upon a pose change 29 of the display pose 19 of the head-mounted display 17 and the pose signal 36 of the display pose 19 and the pose signal 37 of the vehicle pose 15 can be used hereto.

On the left side, FIG. 2 illustrates a bird's eye view to the motor vehicle 10 in the real external environment 11. In the illustrated example, it is assumed that the motor vehicle 10 currently performs cornering K, whereby a yaw rate B with respect to the external environment 11 results for the motor vehicle 10 and thereby for its vehicle pose 15. In the interior 18 of the motor vehicle 10, the user 16 can effect the pose change 29 of the head-mounted display 17 by rotating his head H, on which he wears the head-mounted display 17, in the meantime. Hereby, an angular speed or rotational speed A results for the head-mounted display 17 with respect to the interior 18 of the motor vehicle 10. It is to be noted that the rotational speed in the pose change 29 of the head-mounted display 17 with respect to the external environment 11 thus is the sum of the rotational speed A and the yaw rate B, thus A+B. Correspondingly, the display pose 19 changes and a pose change 42 of the head-mounted display 17 with respect to both the motor vehicle and the external environment arises.

In FIG. 2 on the right side, the view 21 to the virtual environment 20 overlaid on the field of view of the user by means of the head-mounted display 17 is illustrated. The virtual cockpit is represented as a virtual object 22 and the background panorama 24 with the background elements 25 as a virtual object 23. At least for calculating the intermediate frames 41, but preferably generally also for rendering new frames 40, a pose change 43, which can be a pixel shift 44 in case of the homographic reprojection, can be calculated based on or as a function of the pose signals 36, 37 for the virtual object 22, and/or in newly calculating or newly rendering the frames 40, a pose change 43 can be effected by newly calculating the respective object pose.

A virtual object 23 in the background panorama 24, thus a virtual object static with respect to the external environment 11, is represented changed with a pixel shift 46 in the intermediate frames 41, which is greater than the pixel shift 44 in the illustrated example. Because for the virtual object 23 in the background panorama 24, a rotational rate with respect to the head-mounted display 17 from the sum A+B applies in the illustrated example, while only the angular speed A of the head-mounted display 17 with respect to the interior 18 is to be taken as a basis for the pixel shift 44 of the cockpit with respect to the user. For newly rendering or the pixel shift 44, this can be differentiated based on the pose signals 36, 37.

In particular to be able to apply the correct pixel shifts 44, 46 separately from each other, it can be provided to render the view 20 in different contextual layers 50, wherein the virtual object 23 of the background panorama 24 can for example be rendered in a background layer (background level) or global layer 51, thus the pixels of the virtual object 23 can be calculated or generated in a graphics memory of the global layer 51, in particular for the pixel shift 46. In a contextual layer for the virtual cockpit, the cockpit layer 50, the corresponding or associated virtual object 22 can be generated in a cockpit layer 52 in rendering 38 and/or in the pixel shift 44. By composing or compositing, i.e. by superimposing the pixels of the cockpit layer 50, the current view 21 of the virtual environment 20 can be provided in the compositing 53, i.e. the frames 40 and/or the intermediate frames 41 can here be generated by the compositing 53.

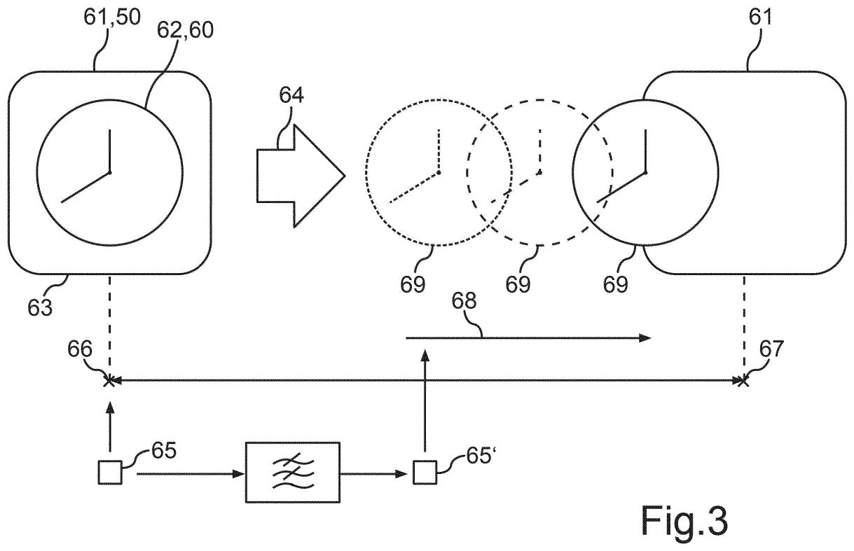

FIG. 3 illustrates how for the cockpit layer 50 and a dynamic-reduced contextual layer 60 associated therewith or coupled thereto, a composite virtual object with a display frame 61 as the virtual object of the cockpit layer 50 and a display content 62 illustrated therein as the virtual object of the dynamic-reduced contextual layer 60. FIG. 3 illustrates it using the example of a display frame 61 of a watch and a display content 62 in the form of an analog clock face 63. By a head movement of the user, a position change 64 for the objects in both layers, the cockpit layer 50 and the dynamic-reduced contextual layer 60, can arise. A pose signal 65 can preset a new target pose 67 for all of the objects of the two contextual layers 50, 60 starting from a start pose 66. Herein, the cockpit layer 50 can provide that it is directly followed the pose signal 65 and thus the display frame 61 as a virtual object of the cockpit layer 50 is set or placed or positioned to the new target pose 67 such that the display frame 61 follows with the dynamics of the head movement and thus takes the respective signal value of the pose signal 65 as a specification for the target position 67 and the positioning there.

In contrast, the dynamic-reduced contextual layer 60 provides to strive for or move towards the new target pose 67 preset by the pose change 64 in multiple intermediate steps, i.e. over multiple frames with a reduced speed of change 68. FIG. 3 illustrates it by multiple illustrated intermediate steps 69, which can each be displayed for example for the duration of one frame or one frame long. The illustrated clock face 63 thus moves stepwise to the final target pose 67 in the display frame 61. In the meantime, however, it seems to the user as if the display content 62 (in the form of the clock face 63 in the example) with respect to the display frame 61 would be shifted with respect to the display frame 61 (due to the different speed of change of the positions of the objects 61, 63). The dynamic-reduced pose signal 65′ artificially generated hereto can for example be generated from the pose signal 65 of the cockpit layer 50 by means of a low-pass filter 70.

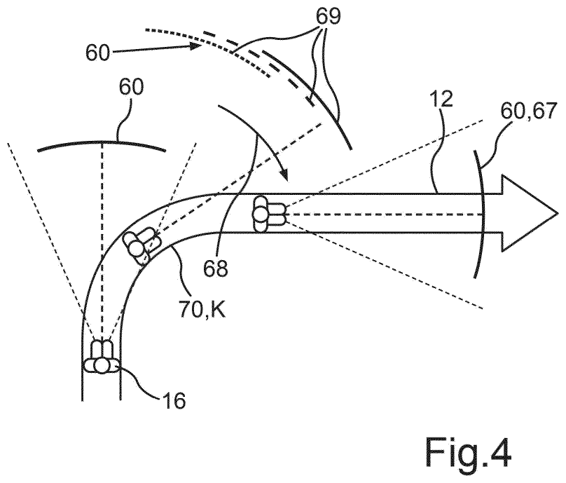

FIG. 4 illustrates in an alternative representation, how during a journey on the road 12 in a curve 70, the rubber band effect helps the user 16 also without movement of his head in relation to the motor vehicle to view a virtual object in the dynamic-reduced contextual layer 60 in that a virtual object is moved in the dynamic-reduced contextual layer 60 with a speed of change 68 during a travel of the motor vehicle through the curve 70, which is lower than the angular speed B (see FIG. 2), which arises in the travel through the curve 70. Only after the curve 70 with further straight travel, the cockpit layer 60 or the virtual object contained therein, then finally or ultimately takes the target pose 67 arising in the straight travel. Thus, the rubber band effect can also be provided in case of absent head movement or head kept still, namely upon a rotation or yaw movement of the motor vehicle in the environment.

Thus, in order to be able to faster update the represented image of a view, one can shift the old frame pixel-wise to the left on the screen (pixel shift) in the meantime (until the new frame is calculated), which each results in an intermediate frame. I.e. upon a rotation by the angle α to the right, so many pixels to the left arise (FIG. 2). This technology is referred to as ATW: https://en.wikipedia.org/wiki/Asynchronous_reprojection. This is usually a hardware solution, because nothing is to be calculated, but the data content is pixel-wise shifted to the right or left in the graphics memory as fast as possible to obtain a shifted old frame or ATW frame.

VR in the motor vehicle, e.g. car, with the special representation that one also sits in a virtual cockpit (virtual car) in the VR representation and views through the window panes of the cockpit to the outside into a virtual environment of a VR world, ATW cannot be as easily solved by a pixel shift. The reason for this is in that upon cornering of the real car, the real car itself already executes a rotation with respect to the real environment, namely with the yaw rate B. In addition, the user in the real car can then additionally rotate his head by the angle A with respect to the real car.

In the VR perspective, the user sees his virtual cockpit and the virtual environment through the window panes. Therein, the virtual cockpit rotates with respect to the user only with the angular speed A (because the user sits quietly in the car and only his head rotates). In contrast, the virtual background of the virtual environment rotates with the angular speed A plus the yaw rate B because the user is additionally rotated in his real motor vehicle with the yaw rate B in the real environment.

Now, if one whishes to apply the pixel shift or ATW, thus, to shift the old frame pixel-wise on the screen in a quick way until the next newly calculated frame is available, one is now capable of separately determining by how many pixels the old frame is to be shifted e.g. to the left if the user rotates the head e.g. to the right with the angular speed A by a measured angle in the real motor vehicle.

In the in-car VR application, a further contextual layer exists hereto, which is transformed with the pose of the car: The virtual vehicle consisting of cockpit (e.g. seats, instruments, control elements), body (e.g. A-pillar, hood, side mirrors) as well as the avatar of the user. This pose is neither in the constant proportion to the global space nor to the fixed space and thus describes a new “car space” of the cockpit layer. If the car performs cornering and if the user keeps the head rigidly on the seat, an artifact is reduced. If the user additionally moves his head during cornering, however, this movement does not match with the fixed rendering layer. A correct warping result can only be effected if the homographic reprojection matrix is applied against the pose signal of the sensor response of the car (e.g. IMU—inertial measurement unit) and this modified asynchronous time warp is only applied to virtual objects, which are rigidly connected to the car. In the final compositing step, the corrected rendering layer can finally be inserted between the contextual layers of the corrected global space and fixed space.

If such a car space is not made available, texts and selection menus are readable in aggravated manner in cornering as a result, the perceived quality is reduced by jerky movements and the probability of the motion sickness is increased. A further solution to counteract these effects, is the artificial addition of an inertial moment to the transformation of the car space. If the car performs cornering, a menu located in the image for instance pivots after in decelerated manner (in other context also known and referred to as rubber banding). Hereby, the disparity between car space and global space is reduced and also the artifact strength. Since the original artifact strength is depending on the frame rate as initially described, the strength of the rubber banding can also be effected depending thereon and be adaptively adapted: If a high frame rate is measured, the rubber banding is reduced, increased with low frame rates. In our experiments, texts are considerably better readable and the additionally required head movement to follow the menu in curves is not perceived as particularly annoying by the users.

However, not only the perception quality/precision of granular structures like text becomes better, but overall the quality of the user experience, since for example surrounding cockpit structures or objects are also considerably smoother represented.

### LIST OF REFERENCE CHARACTERS

10 motor vehicle
11 external environment
12 road
13 environmental element
14 vehicle movement
15 vehicle pose
16 user
17 head-mounted display
18 interior
19 display pose
20 virtual environment
21 view
22 object
24 background panorama
25 element
25 background elements
26 coordinate system
27 coordinate system
29 pose change
30 processor circuit
31 data interface
32 motion sensor
33 sensor signal
34 motion sensor
35 sensor signal
36 pose signal
37 pose signal
38 rendering
40 frames
41 intermediate frames
42 pose change
43 pose change
44 pixel shift
46 pixel shift
50 cockpit layer
51 global layer
52 cockpit layer
53 compositing
K head

1. A method for operating a head-mounted display (17) in a motor vehicle (10) while the motor vehicle (10) performs a journey through a real external environment (11), wherein
a view (21) of a virtual environment (20) comprising virtual objects (22) is overlaid on a field of view of a user (16) by a processor circuit (30) using the head-mounted display (17) and in rendered frames (40) of the view (21) that are successively newly rendered at a preset frame rate, a coordinate system (26, 27) of the virtual environment (20) is kept congruent with a coordinate system (26, 27) of the real external environment (11) such that a change of a display pose (19) of the head-mounted display (17) with respect to the real external environment (11) caused by a head movement of the user (16) and/or a travelling movement of the motor vehicle (10) in the real external environment (11) is simulated by shifting and/or rotating the view (21) of the virtual environment (20), wherein the shift and/or rotation is performed as a function of at least one pose signal (36, 37), which describes the new display pose (19) and/or vehicle pose (15) resulting from the head movement and/or the travelling movement,
characterized in that
pixels of the respective frame (40) are rendered in at least two different contextual layers and the respective frame is thereafter composed of the pixels of the contextual layers, wherein in each of the contextual layers the pixels of different ones of the virtual objects (22) are represented and for newly rendering (38) the frames (40) for shifting and/or rotating the view (21), different pose signals (36, 37) are taken as a basis in at least two of the contextual layers.

2. The method according to claim 1, wherein after displaying the respective currently rendered frame (40) and before the next frame is readily rendered, at least one intermediate frame of the view (21) is generated using a homographic reprojection and displayed, wherein the intermediate frame is generated by a pixel shift (44, 46) of pixels representing the virtual objects (22) of the current frame (40) in the respective contextual layer, wherein a shift extent of the pixel shift (44, 46) is separately performed individually for the respective contextual layer depending on the at least one pose signal (36, 37) used therein, and thereby the pixel shift (44, 46) each has a different shift extent and the respective intermediate frame is composed of the shifted pixels of the contextual layers.

3. The method according to any one of the preceding claims, wherein an absolute pose signal (36, 37), which describes the display pose (19) with respect to the external environment (11), is applied in one of the contextual layers and thereby an global layer (51) coupled to the real external environment (11) is provided and a pose signal (36, 37), which describes a vehicle pose (15) of the motor vehicle (10) with respect to the external environment (11), is applied in a different one of the contextual layers and thereby a cockpit layer (50, 52) is provided, in which a cockpit and/or a body of a virtual representation of an interior (18) of the motor vehicle (10) and/or an avatar of the user (16) is provided as a virtual object (22).

4. The method according to claim 3, wherein a different one of the contextual layers is coupled to the cockpit layer, in which a restricted pose signal (36, 37), which indicates the change of the display pose (19) of the head-mounted display (17) with a limited dynamic with respect to the change of the display pose (19), is applied and thereby a dynamic-limited contextual layer is provided.

5. The method according to claim 4, wherein a current target pose of the virtual object (22) in the dynamic-limited contextual layer is each read out of the current signal value of the pose signal of the cockpit layer and the shift and/or rotation is performed in the dynamic-limited contextual layer until an actual pose of the virtual object (22) in the dynamic-limited layer reaches the target pose, wherein in the dynamic-limited contextual layer the restricted pose signal (36, 37) hereto enforces a speed of change of the object pose of the virtual object (22) that is limited with respect to magnitude to a predetermined maximum value greater than zero, in particular by a limitation of the magnitude to a maximum rotational rate.

6. The method according to claim 5, wherein the maximum value is adjusted as a function of a current value of the frame rate.

7. The method according to any one of claims 4 to 6, wherein the virtual object (22) is a granular structure in the dynamic-limited contextual layer, which represents a text and/or a value display and/or an operating menu.

8. The method according to any one of the preceding claims, wherein at least one of the pose signals (36, 37) is generated as a function of a respective sensor signal (33, 35) of at least one motion sensor (32, 34) of the head-mounted display (17) and/or one of the pose signals (36, 37) is generated as a function of a respective sensor signal (33, 35) of at least one motion sensor (32, 34) of the motor vehicle (10).

9. The method according to any one of the preceding claims, wherein the shift extent of the pixel shift (44, 46) is rendered as a function of a difference from a sensor signal (33, 35) of a motion sensor (32, 34) of the motor vehicle (10) and a sensor signal (33, 35) of a motion sensor (32, 34) of the head-mounted display (17) in at least one contextual layer and/or wherein the shift extent of the pixel shift (44, 46) is calculated as a function of a tracking signal of a head tracker of the head-mounted display (17) operated in the motor vehicle (10) in a contextual layer.

10. The method according to any one of the preceding claims, wherein the shift extent of the pixel shift (44, 46) is generated as a function of a sensor signal (33, 35) of a yaw rate sensor of the motor vehicle (10) in at least one contextual layer, which signals a yaw rate of the motor vehicle (10) with respect to the external environment (11).

11. A processor circuit (30) for operating a head-mounted display (17), wherein the processor circuit (30) comprises a data interface (31) for receiving a respective sensor signal (33, 35) of at least one motion sensor (32, 34) and wherein the processor circuit (30) is configured to calculate at least one pose signal (36, 37), which describes a new display pose (19) and/or vehicle pose (15) resulting from a head movement of a user (16) wearing the head-mounted display (17) and/or from a travelling movement of a motor vehicle (10), from the at least one received sensor signal (33, 35) and to perform a method according to any one of the preceding claims.

12. A head-mounted display (17) with a processor circuit (30) according to claim 11.

13. A motor vehicle (10) with a sensor circuit comprising at least one motion sensor (32, 34) for generating at least one sensor signal (33, 35), which signals a temporal course of a vehicle position and/or of a speed and/or of an acceleration of the motor vehicle (10) with respect to an external environment (11) of the motor vehicle (10), wherein the motor vehicle (10) comprises a transmission circuit, which is configured to transmit the at least one sensor signal (33, 35) to a processor circuit (30) according to claim 11.
